(19) United States
(12) Patent Application Publication
(10) Pub. No.: US 2009/0319643 A1
(43) Pub. Date: Dec. 24, 2009

(54) AUTOMATED METHOD FOR TRANSFERRING FILES AND SETTINGS TO NEW COMPUTER

(75) Inventor: Adrian Crisan, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/141,462

(22) Filed: Jun. 18, 2008

(51) Int. Cl. G06F 15/177

(52) U.S. Cl. 709/221

(57) ABSTRACT

A user accesses a website to purchase a replacement computer. As part of the transaction an application is downloaded to an existing computer of the user and used to obtain personal files and settings of the existing computer, which are uploaded to an Internet server. The settings and files may be loaded onto the replacement computer prior to delivery or after delivery, over the Internet.

### I. FIELD OF THE INVENTION

The present invention relates generally to automatically transferring files and settings from an old computer to a new computer as part of the purchase transaction.

### II. BACKGROUND OF THE INVENTION

When a user wishes to replace an old computer with a new one, it is ordinarily necessary to transfer files from the old computer to the new one. For example, the user ordinarily wishes to transfer personal text files, digital photographs, and the like to the new computer, as well as to transfer certain settings such as computer name, user name, password, location of file storage, network settings, and the like, so that changing to the new computer is as little disruptive as possible.

To effect the transfer, the user typically must purchase transfer software or retain a consultant to move the information from the old computer to the new computer. This typically requires a local area network to which both computers may be connected to effect communication. As understood herein, this can be costly, time-consuming, and often frustrating to non-expert users who attempt to transfer the files themselves.

### SUMMARY OF THE INVENTION

A method includes allowing a user to access a website to purchase a replacement computer. The method also includes the automatic or prompted downloading of an application to an existing computer of the user and using the application to obtain personal files and settings of the existing computer. The personal files and settings are uploaded to an Internet server with some of the settings converted as appropriate for the replacement computer. The personal files and settings are then placed onto the replacement computer. A secure electronic mechanism can be used to tie the customer's order record with the customer's personal information.

The loading may be undertaken prior to delivery of the replacement computer to the user. Or, the loading may be undertaken after delivery of the replacement computer to the user. The personal files can include personal digital photographs, personal text files, and the like, while the settings can include file locations on a storage medium, network settings, etc.

In another aspect, a server computer includes a processor configured to receive a user order for a replacement computer and in response downloading an application to an existing computer. The application is executable by the existing computer to discover personal files and/or settings of the existing computer and to upload the files and/or settings to the Internet for storage thereof such that the files and/or settings can be loaded onto the replacement computer without intervention by the user.

In yet another aspect, a replacement computer ordered by a user of an existing computer receives personal files and settings of the existing computer over the Internet pursuant to a sales transaction for the replacement computer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic block diagram of a non-limiting system in accordance with present principles;

FIG. 2 is a flow chart showing non-limiting logic for storing the files and settings of the old computer on an Internet server database;

FIG. 3 is a flow chart showing non-limiting logic for loading the files and settings onto the new computer prior to delivery; and

FIG. 4 is a flow chart showing non-limiting logic for loading the files and settings onto the new computer after delivery.

### DETAILED DESCRIPTION OF THE PREFERRED EMBODIMENT

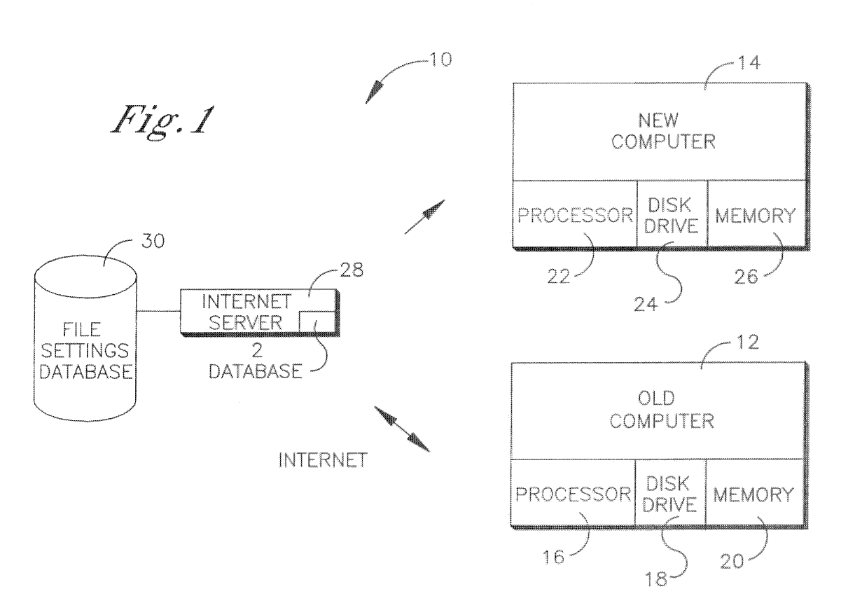

Referring initially to FIG. 1, a system is shown, generally designated 10, for transferring personal files such as, e.g., text documents and photographs, from an old computer 12 to a new computer 14 as part of the transaction by which a user of the old computer 12 purchases the new computer 14. As shown, the old computer 12 includes, among other components, a processor 16, one or more disk drives 18 such as hard disk drives, optical drives, and solid state memory 20. Likewise, the new computer 14 includes, among other components, a processor 22, one or more disk drives 24 such as hard disk drives, optical drives, and solid state memory 26.

To purchase the new computer 14, the user operates the old computer 12 to access an Internet purchase server 28 with server processor 28a over the Internet. The server 28 may be associated with a file and settings database 30. Files, settings, and other information from the old computer 12 can be uploaded to the database 30 for loading onto the new computer 14 in accordance with logic below.

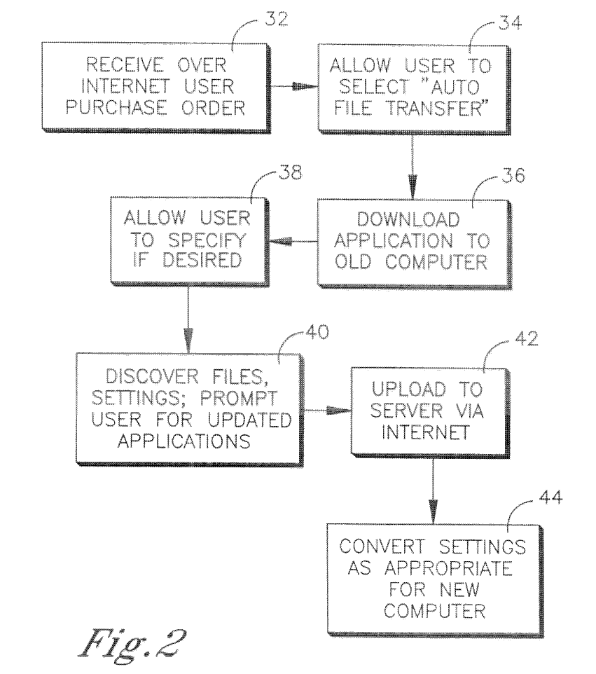

FIG. 2 shows illustrative non-limiting logic for storing the files and settings of the old computer on an Internet server database. Commencing at block 32, the server 28 receives over the Internet a purchase order from the old computer 12 for the new computer 14. As part of the transaction, at block 34 the server may ask the user whether the user wishes to effect automatic transfer of personal files and settings from the old computer to the new computer, and assuming the user agrees, the logic moves to block 36 to download a transfer utility or application to the old computer over the Internet.

The transfer application is executable by the processor 16 of the old computer 12 to effect logic including allowing the user, at block 38 in response to a prompt from the application, to specify what files and/or file types and/or file locations on disk to transfer to the new computer 14. Likewise, the settings and/or setting types, etc. may be specified by the user for transfer. Alternatively, all files and settings may be automatically made candidates for transfer without user interaction. The settings may include, by way of example, directory and/or disk locations of text document files, network settings such as wireless communication settings, location of template files, desktop information such as the name of the computer, the user's name and password, shortcuts to be represented by icons on the desktop screen, etc.

At block 40, in response to the user specification at block 38 (or automatically if no user specification is used), personal files and settings to be transferred are discovered by the application. Also, the application may prompt the user to order updated applications if desired. For example, if the application discovers photograph files, it might prompt the user to indicate whether the user wishes to purchase an updated photo viewer application with the new computer. Likewise, an entire updated suite of applications may be prompted for at block 40.

Proceeding to block 42, the discovered files and settings, along with whatever user selection of updated applications might have been made, are uploaded to the server 28 for storage in the database 30, correlating the uploaded package of information with the purchase information related to the new computer (e.g., with the SKU or purchase order of the new computer and also with the user's identity information if desired). If desired, the settings may be converted at block 44 as appropriate for the new computer 14. For example, if a suite of year 2000 software is to be updated to a 2008 version of the suite, some settings such as file locations, etc. may require changing, and this conversion of particular settings as appropriate for the new computer 14 may be effected at the server 28.

FIG. 3 at block 46 indicates that prior to delivering the new computer 14 to the user, at block 48 the updated applications, files, and settings, including any converted settings, are loaded onto the new computer 14. The new computer 14 is then delivered to the user at block 50.

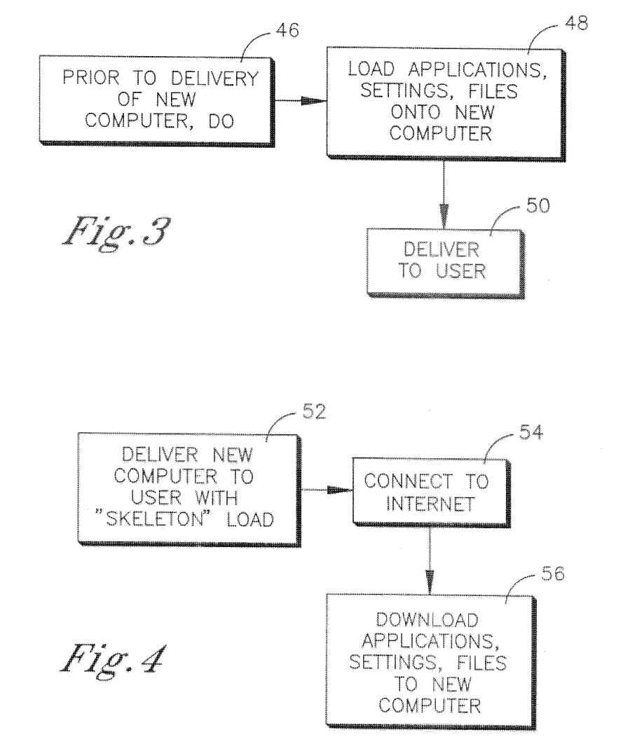

Alternatively, Block 52 in FIG. 4 indicates that the new computer 14 may be delivered to the user with only a skeleton computing capability onboard that is sufficient to undertake connection to the Internet at block 54 to effect downloading at block 56 of the user's files, settings, etc. from the server 28 after delivery. An entire software suite may be preloaded for delivery at block 52, in which case only the user's files and settings need be downloaded at block 56.

While the particular AUTOMATED METHOD FOR TRANSFERRING FILES AND SETTINGS TO NEW COMPUTER is herein shown and described in detail, it is to be understood that the subject matter which is encompassed by the present invention is limited only by the claims.

What is claimed is:

1. A method comprising:
allowing a user to access a website to purchase a replacement computer;
downloading an application to an existing computer of the user;
using the application to obtain personal files and settings of the existing computer;
uploading the personal files and settings to an Internet server;
converting at least some of the settings as appropriate for the replacement computer; and
loading the personal files and settings onto the replacement computer.

2. The method of claim 1, wherein the loading act is undertaken prior to delivery of the replacement computer to the user.

3. The method of claim 1, wherein the loading act is undertaken after delivery of the replacement computer to the user.

4. The method of claim 1, wherein the personal files include personal digital photographs.

5. The method of claim 1, wherein the personal files include personal text files.

6. The method of claim 1, wherein the settings include at least one file location on a storage medium.

7. The method of claim 1, wherein the settings include at least one network setting.

8. A server computer comprising:
at least one processor configured to receive a user order for a replacement computer and in response downloading at least one application to an existing computer, the application being executable by the existing computer to:
discover personal files and/or settings of the existing computer;
upload the files and/or settings to the Internet for storage thereof such that the files and/or settings can be loaded onto the replacement computer without intervention by the user.

9. The server computer of claim 8, wherein the server computer converts at least some of the settings as appropriate for the replacement computer.

10. The server computer of claim 8, wherein the server computer loads the personal files and settings onto the replacement computer.

11. The server computer of claim 10, wherein the replacement computer is loaded with the files and settings prior to delivery of the replacement computer to the user.

12. The server computer of claim 10, wherein the replacement computer is loaded with the files and settings after delivery of the replacement computer to the user.

13. The server computer of claim 8, wherein the personal files include personal digital photographs.

14. The server computer of claim 8, wherein the personal files include personal text files.

15. The server computer of claim 8, wherein the settings include at least one file location on a storage medium.

16. The server computer of claim 8, wherein the settings include at least one network setting.

17. A replacement computer ordered by a user of an existing computer and receiving personal files and settings of the existing computer over the Internet pursuant to a sales transaction for the replacement computer.

18. The replacement computer of claim 17, wherein the personal files include personal digital photographs and/or personal text files.

19. The replacement computer of claim 17, wherein the settings include at least one file location on a storage medium.

20. The replacement computer of claim 17, wherein the settings include at least one network setting.
